(19) United States
(12) Patent Application Publication
(10) Pub. No.: US 2008/0258903 A1
(43) Pub. Date: Oct. 23, 2008

(54) Multifunctional Powerline Sensor Network

(76) Inventors: Kevin Le, Richland Hills, TX (US); Thanh La, Grand Praire, TX (US)

Correspondence Address: WILSON DANIEL SWAYZE, JR., 3804 CLEARWATER CT., PLANO, TX, 75025, US

(21) Appl. No.: 11/738,493

(22) Filed: Apr. 22, 2007

(51) Int. Cl. G08B 29/00

(52) U.S. Cl. 340/506

(57) ABSTRACT

A multifunctional powerline sensor network used for fire, toxic chemical gases and intruder detections. The network is comprised a master device, an array of sensor nodes, a host device/computer and the existing powerlines in the building/facility. This network offers many advantages including cost effectiveness, multifunction, high integration and ease of installation. The master device communicates with all the sensor nodes via the powerlines. When the motion sensors are enabled, the network converts to a advanced security alarm system that provides an alert when the security of the facility has been compromised by locating and tracking the position of the intruder.

### BACKGROUND OF THE INVENTION

After the September 11^{th} terrorist attacks, there has been an increasing concern about the security of business and public facilities. Many companies and government agencies are spending significant amounts of funding for developing an apparatus to detect the toxic chemical gases in case of a terrorist chemical attack.

Many solutions have been proposed, and sensing devices have been developed to detect the common toxic chemical gases such as CO and NOx; however, the implementation of these sensors have been restricted due to the high cost of the sensors and the difficulty of installing the sensors. Most of the current sensor networks use either wireless or twisted pairs for the network communication. Wireless apparatus is not very secure and is not reliable because interference and other environmental factors can affect signal strength. Using twisted pairs can provide for more reliable communication; however, this technique often requires a significant labor intensive installation especially in existing concrete buildings. In addition, most of these existing buildings have been installed with pre-existing fire alarm and security systems. Adding a separate chemical sensor network to the facility will result in a high installation and maintenance cost due to the need to add additional cabling.

Accordingly, there is a need in the art for effective single network to monitor all the environmental parameters, toxic gases and security parameters that is efficient, low cost, easy to install and easy to maintain. The present invention is directed to such device.

### SUMMARY OF INVENTION

The present invention meets the need in the art by providing a single network to detect and locate the source of toxic chemicals and fire. In addition, the present invention includes a security system that provides an alert when the security of the facility has been compromised by locating and tracking the position of the intruder.

The present invention comprises an array sensor nodes to collect data, a master device and a host device/computer to process the data. The sensor network of the present invention can be implemented with a large number of sensor nodes spread across a large geographical area. Each sensor node may include multiple sensing devices, including a smoke sensor to detect the early stage of fire, an infrared sensor to sense the motion of an intruder, and a chemical sensor to detect NOx, CO and other chemicals. Each sensor node may have built-in electronics including intelligent digital signal processing for decision making capabilities.

All existing buildings have internal pre-existing powerlines. The sensor nodes communicate with the master device via these existing powerlines in the facility. Consequently, no new wires are needed. This feature makes the installation easy and helps reduce further the overall cost of the system. By simply interfacing the sensor nodes with the powerlines, a multifunctional sensor network is installed to detect toxic gasses, fires and also to detect the invasion of an intruder.

The present invention of sensor network is applicable to commercial applications and military applications to assist in a national effort to increase security by detecting potential terrorist chemical threats.

The objects, features, and advantages of the present invention will become apparent upon reading of the following description in conjunction with the drawings and the appended claims.

### BRIEF DESCRIPTION OF THE DRAWINGS

FIG. 1 is a system diagram of the system-level implementation of the present invention.

FIG. 2 is a circuit block diagram of the master device 10 of the present invention.

FIG. 3 is a circuit block diagram of the sensor node 12 of the present invention.

FIG. 4 is a perspective view of the master device 10 of the present invention.

FIG. 5 is a perspective view of the sensor node 12 of the present invention.

### DETAILED DESCRIPTION OF THE INVENTION

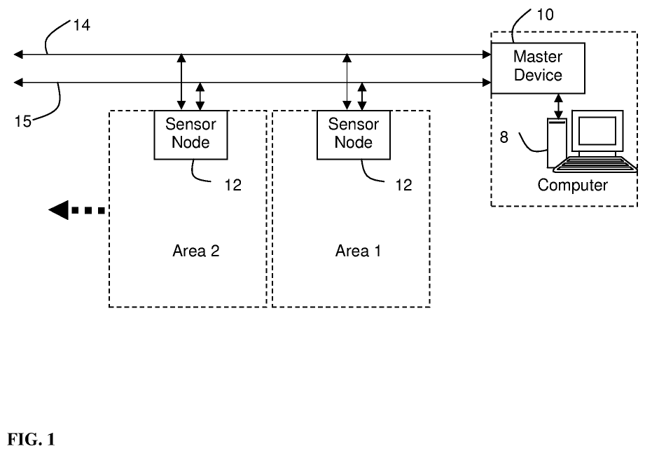

With reference to the drawings, in which like parts have like identifiers, FIG. 1 shows a system diagram of the system-level implementation of the present invention. As shown in FIG. 1, the system includes a master device 10 and an array or a network of sensor nodes 12. Generally, the numbers of sensor nodes 12 should not be limited. The master device 10 communicates with all the sensor nodes 12 via the existing powerlines 14, 15 in the facility where the network is installed. The sensor node 12 detects the presence of various chemicals, fire, or intruders and communicates with the master device 10 when the presence is detected. The master device 10 is interfaced with the host device/computer via a USB cable. Generally, the host device can be a computer or a stand alone system.

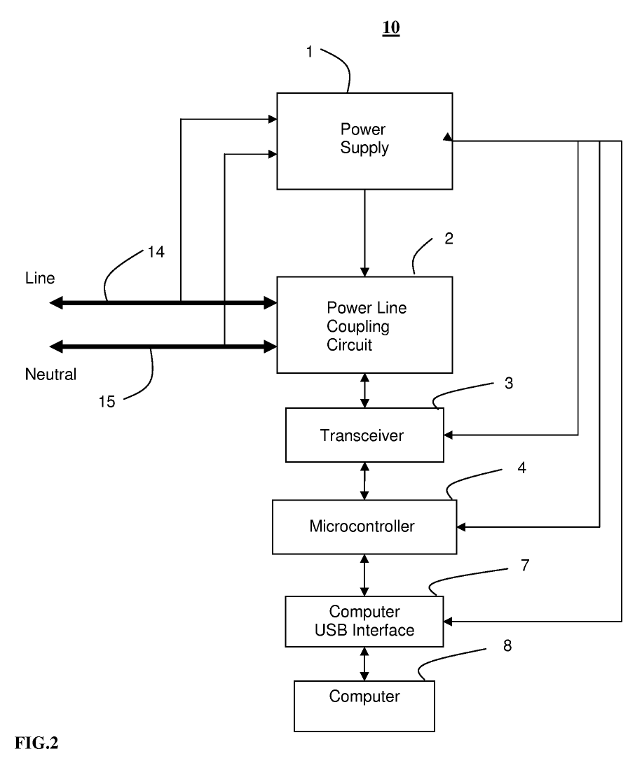

FIG. 2 illustrates a block circuit diagram of the master device 10. The power supply 1 takes the AC power from and the powerlines 14 and 15 and coverts it to DC power by the power supply circuit 1. This DC power is used to power the entire master device 10. Data from the sensor nodes 12 are transmitted to the master device 10 via the powerlines 14, 15. Then, the sensor data is transmitted to the host device/computer by the master unit 10. When the data is received by the master device 10, the data is first received by the analog front-end circuit 2 which is shown as the power line coupling circuit and then transmitted to the transceiver 3. Then, the data is transmitted to and pre-processed by microcontroller 4 and is transmitted to the host device/computer 8 via USB interface 7.

The host device/computer 8 receives further processes and displays the data received from the master device 10. This host computer/device 8 can further forward the data to a security office by the internet or telephone lines if the connection is available. The communication between the master device 10 and sensor nodes 12 is bidirectional so that the master device 10 can also send data to all of the sensor nodes 12. This feature allows the host device/computer to trigger an alarm on a specific sensor node 12 or on all sensor nodes 12 in case the evacuation or warning is necessary or desirable for a particular area or entire facility.

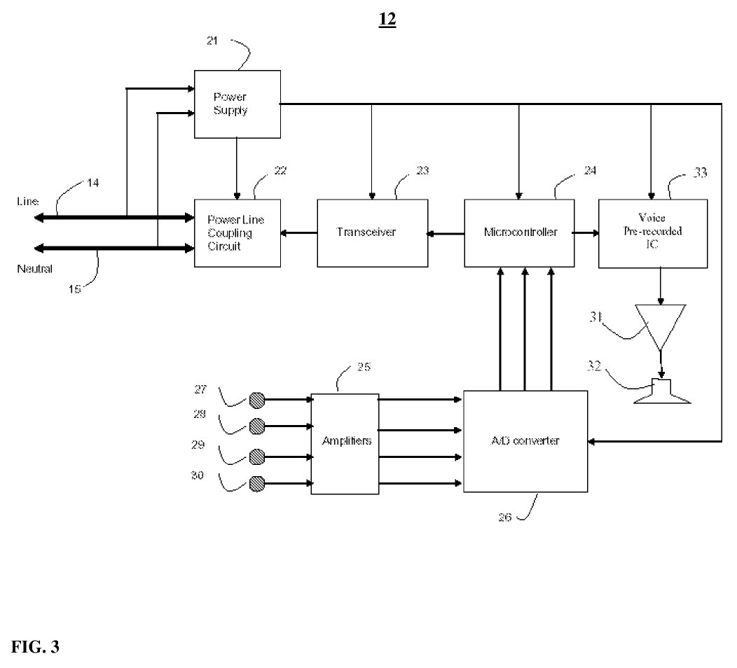

FIG. 3 is a block circuit diagram of a sensor node 12. The outputs of the smoke sensor 27, CO sensor 28, NOx sensor 29, and motion sensor 30 are interfaced with analog circuit and amplifier 25. The sensor signals from one or any of the smoke sensor 27, CO sensor 28, NOx sensor 29 and motion sensor 30 are digitized by analog to digital converter (A/D) 26. Generally, the number and types of sensors are not limited in order to detect different gases and other environmental parameters. In this invention, the A/D 26 may be integral with the Texas Instrument MSP430 microcontroller 24. The microcontroller 24 receives the data from A/D 26 and compares it with the preset data (for example a predetermined threshold level) for each sensor 27, 28, 29, 30, and if the predetermined threshold level is exceeded by the data, the microcontroller 24 makes the decision to trigger the alarm. If the sensor data exceeds the preset level, the microcontroller 24 will trigger the alarm for example by enabling the voice pre-recorded IC 33, and thus an automatic voice announcement is played on the sensor node speaker 32 with the support of amplifier 31 which may be integral with the sensor node 12. Alternatively, in the lower cost version of the sensor node 12, the voice recorded IC 33 and the speaker 32 can be replaced by a audible buzzer. The data from the microcontroller 24 is then transmitted to the MAC transceiver 23 which transmits the data to the coupling circuit 22 which converts the data to analog and transmits the analog data to the master device 10 via the powerlines 14, 15.

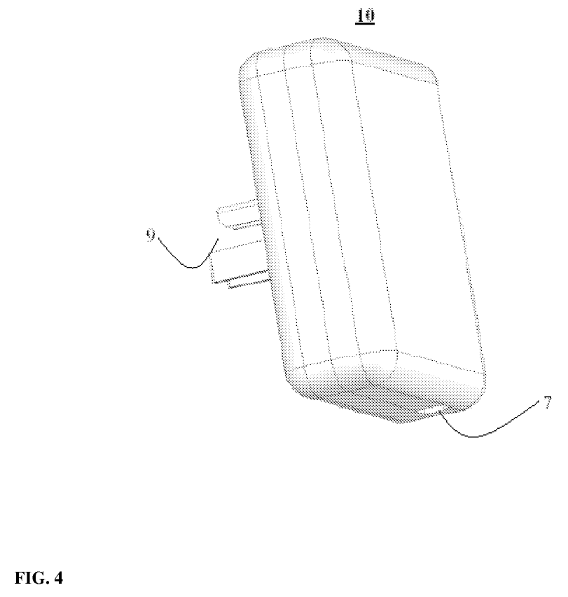

FIG. 4 shows a perspective view of the master device 10. This master device 10 is plugged into a power outlet with the standard power pins 9 as an interface and a USB port 7. This interface allows the master device 10 to communicate with all the sensor nodes 12 in the network via the powerlines 14, 15. The master device 10 communicates with the host computer PC 8 via the USB port 7.

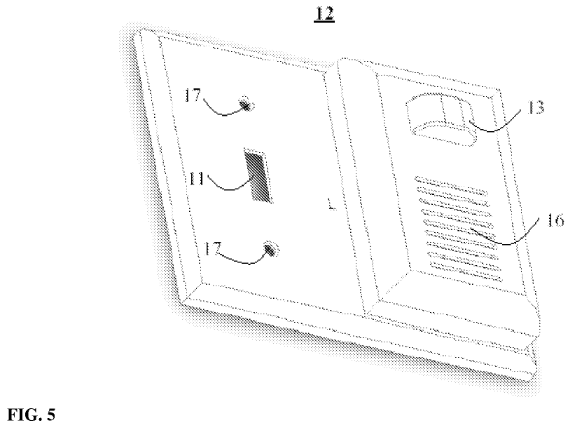

FIG. 5 shows a perspective view of the front housing for the sensor node 12. This sensor node 12 can be installed anywhere in the facility where powerlines 14, 15 or a wall switch is available. The sensor node 12 detects the motion via motion sensor window 13. A plurality of air intakes 16 allows the internal smoke and chemical gas sensors to detect the smoke and chemical gases in the air. The sensor node 12 is installed by simply removing the wall switch cover and connecting the sensor node 12 with the powerlines 14, 15 that are available at the switch. The installation of the sensor node 12 will not affect the switch due to the availability of installation holes 17 and 11 on the sensor housing. The sensor node 12 is integral with the wall switch cover.

1. A multifunctional powerline sensor network, comprising:
a master device that interfaces with a host device/computer;
a sensor node to communicate with the master device;
a powerline network as a communication medium between the sensor node and the master device.

2. The multifunctional powerline sensor network according to claim 1, wherein the sensor node is multi-functional and is used to detect at least one of smoke, toxic gases and motion.

3. The multifunctional powerline sensor network according to claim 1, wherein the sensor node can detect an intruder and locate and track a position of the intruder.

4. The multifunctional powerline sensor network according to claim 1, wherein the sensor node includes a integral voice sounder.

5. The multifunctional powerline sensor network according to claim 1, wherein the powerline network is a medium for data communication.

6. The multifunctional powerline sensor network according to claim 1, wherein the master device receives data from a plurality of the sensor nodes and forwards data to the host device/computer.

7. The multifunctional powerline sensor network according to claim 1, wherein the sensor node is connected to the powerline network at a wall light switch.

8. The multifunctional powerline sensor network according to claim 7, wherein the sensor node is integral with a wall switch cover.

9. The multifunctional powerline sensor network according to claim 1, wherein the master device communicates with a plurality of sensor nodes via the powerline network.

11. The multifunctional powerline sensor network according to claim 1, wherein the master device communicates with the host device/computer via a USB interface.

12. The multifunctional powerline sensor network according to claim 1, wherein the master device and the host can be integrated together to form a single device.
